(19) United States
(12) Patent Application Publication
(10) Pub. No.: US 2024/0175534 A1
(43) Pub. Date: May 30, 2024

(54) PIPE REPAIR STENT WITH STRUCTURAL CHASSIS

(71) Applicant: Mueller International, LLC, Atlanta, GA (US)

(72) Inventors: Sean Michael Allen, Chattanooga, TN (US); Adrian Armaselu, Hixson, TN (US); Skylar Lopez-Kohler, Rochester, MN (US); Avi Chiproot, Kfar Saba (IL)

(21) Appl. No.: 18/072,654

(22) Filed: Nov. 30, 2022

(51) Int. Cl. F16L 55/18; F16L 21/00; F16L 21/08

(52) U.S. Cl. CPC F16L 55/18; F16L 21/005; F16L 21/08

(57) ABSTRACT

A structural chassis for a pipe repair stent includes a first reinforcement ring configured to be received in a first circumferential groove of a gasket; a second reinforcement ring, wherein a chassis axis extends centrally through the first reinforcement ring and the second reinforcement ring, the second reinforcement ring axially spaced from the first reinforcement ring and configured to be received in a second circumferential groove of the gasket; a first groove cover axially aligned with and disposed radially outward of the first reinforcement ring, relative to the chassis axis, to cover and protect the first reinforcement ring; and a second groove cover axially aligned with and disposed radially outward of the second reinforcement ring, relative to the chassis axis, to cover and protect the second reinforcement ring.

### TECHNICAL FIELD

This disclosure relates to the field of pipe repair. More specifically, this disclosure relates to a pipe repair stent comprising a structural chassis.

### BACKGROUND

Piping systems, including municipal water systems, can develop breaks in pipe walls that can cause leaking. Example of breaks in a pipe wall can include radial cracks, axial cracks, point cracks, etc. Repairing a break in a pipe wall often requires the piping system to be shut off, which can be inconvenient for customers and costly for providers. Further, repairs can necessitate grandiose construction, including the digging up of streets, sidewalks, and the like, which can be costly and time-consuming.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts off the disclosure as an introduction to the following complete and extensive detailed description.

Disclosed is a structural chassis for a pipe repair stent comprising a first reinforcement ring configured to be received in a first circumferential groove of a gasket; a second reinforcement ring, wherein a chassis axis extends centrally through the first reinforcement ring and the second reinforcement ring, the second reinforcement ring axially spaced from the first reinforcement ring and configured to be received in a second circumferential groove of the gasket; a first groove cover axially aligned with and disposed radially outward of the first reinforcement ring, relative to the chassis axis, to cover and protect the first reinforcement ring; and a second groove cover axially aligned with and disposed radially outward of the second reinforcement ring, relative to the chassis axis, to cover and protect the second reinforcement ring.

Also disclosed is a pipe repair stent comprising a gasket defining a first gasket end, a second gasket end, an outer gasket surface, and an inner gasket surface, the inner gasket surface defining a main passage centrally through the gasket, a stent axis extending centrally through the main passage, the outer gasket surface defining a first circumferential groove that is oriented proximate to the first gasket end and a second circumferential groove that is axially spaced from the first circumferential groove, relative to the stent axis, and oriented proximate to the second gasket end; and a structural chassis comprising a first reinforcement ring disposed in the first circumferential groove and a second reinforcement ring disposed in the second circumferential groove, the structural chassis further comprising a first groove cover disposed radially outward of and covering the first reinforcement ring, relative to the stent axis, and a second groove cover disposed radially outward of and covering the second reinforcement ring, relative to the stent axis.

Additionally, disclosed is a method of repairing a damaged pipeline with a pipe repair stent, the method comprising providing a gasket of the pipe repair stent, the gasket defining a first gasket end, a second gasket end, an outer gasket surface, and an inner gasket surface, the outer gasket surface defining a first circumferential groove that is oriented proximate to the first gasket end and a second circumferential groove that is oriented proximate to the second gasket end, the pipe repair stent defining a stent axis; transporting the pipe repair stent through a pipeline in a collapsed configuration to a location of damage; expanding the pipe repair stent to an expanded configuration to seal the gasket with an inner wall of the pipeline; and reinforcing the gasket with a first reinforcement ring disposed in the first circumferential groove and a second reinforcement ring disposed in the second circumferential groove.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a pipe repair stent, in accordance with one aspect of the present disclosure.

FIG. 2 is a perspective view of a gasket of the pipe repair stent of FIG. 1.

FIG. 3 is a detail cross-sectional view of the gasket taken along line 3-3 in FIG. 2.

FIG. 4 is a perspective view of a groove cover of the pipe repair stent of FIG. 1.

FIG. 5 is a detail cross-sectional view of the groove cover taken along line 5-5 in FIG. 4.

FIG. 6 is a perspective view of a reinforcement rod of the pipe repair stent of FIG. 1.

FIG. 7 is a perspective view of a structural chassis of the pipe repair stent of FIG. 1.

FIG. 8 is a cross-sectional view of the pipe repair stent taken along line 8-8 in FIG. 1.

FIG. 9 is a cross-sectional view of the pipe repair stent according to another aspect of the present disclosure.

FIG. 10 is an end view of the gasket in a collapsed configuration.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for one or more particular aspects or that one or more particular aspects necessarily include logic for deciding, with or without user input or prompting, whether these features, elements, and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific aspect or combination of aspects of the disclosed methods.

Disclosed in the present application is a repair stent for repairing a damaged pipeline, and associated methods, systems, devices, and various apparatus. The repair stent can comprise a gasket and a structural chassis. It would be understood by one of skill in the art that the disclosed repair stent is described in but a few exemplary aspects among many. No particular terminology or description should be considered limiting on the disclosure or the scope of any claims issuing therefrom.

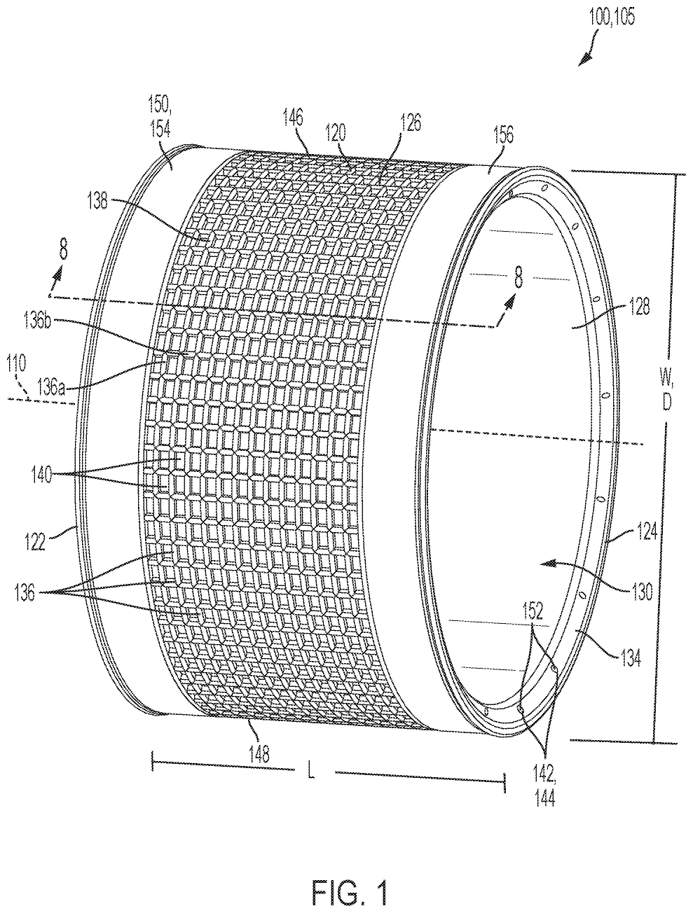

FIG. 1 illustrates a pipe repair device 100 according to an example aspect of the present disclosure. According to example aspects, the pipe repair device 100 can be configured to be expanded within a pipeline where a crack or other damage is present. The pipe repair device 100 can seal with an inner wall of the pipeline to prevent leaking at the site of damage. For example, the pipeline can be municipal water pipeline system, a sewage pipeline system, a gas pipeline system, or any other suitable pipeline system. As described in further detail below, the pipe repair device 100 can be configurable in a collapsed (e.g., folded) configuration for transport through the pipeline to the location of damage and in an expanded configuration (shown) wherein the pipe repair device 100 can seal with the inner wall of the pipeline.

The pipe repair device 100 can be formed as a repair stent 105, for example. Repairing pipe damage with a stent can reduce costs and construction requirements. Stents are typically flexible and/or foldable and/or collapsible to decrease the stent's size for transport through the piping system to the location of the damage. However, the flexibility, foldability, and/or collapsibility of the stent can reduce the structural integrity of the stent, and stents commonly become displaced or are swept away under high flow conditions. The repair stent 105 of the present disclosure is reinforced to improve the structural integrity of the repair stent 105 while still allowing for collapsibility.

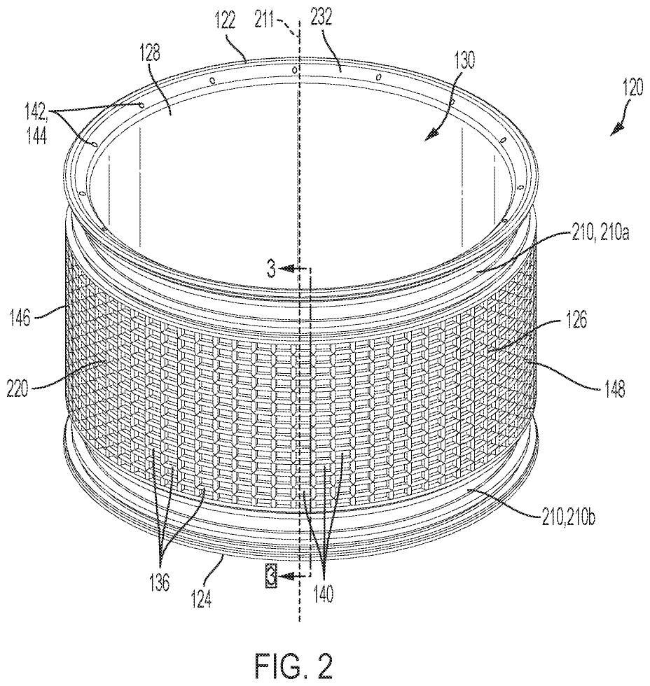

According to the present aspect, the repair stent 105 can comprise a gasket 120 and a structural chassis 150 for reinforcing the gasket 120. The gasket 120 can define a first gasket end 122 and a second gasket end 124. A length L of the repair stent 105 can be defined between the first gasket end 122 and the second gasket end 124. The gasket 120 can be substantially cylindrical in the expanded configuration and can be formed as a continuous, tubular sleeve structure, as shown. The repair stent 105 can define a width W/diameter D, which can be maximized in the expanded configuration of the repair stent 105 and reduced in the collapsed configuration of the repair stent 105. The gasket 120 can further define an outer gasket surface 126 and an inner gasket surface 128. The inner gasket surface 128 of the gasket 120 can define a main passage 130 therethrough. Fluid in the pipeline can be configured to flow through the main passage 130 of the gasket 120 in the expanded configuration. A stent axis 110 of the repair stent 105 can extend centrally through the main passage 130 from the first gasket end 122 to the second gasket end 124. In example aspects, the gasket 120 can taper generally from the outer gasket surface 126 to the inner gasket surface 128 at each of the first gasket end 122 and the second gasket end 124 to define a first tapered end portion 232 (shown in FIG. 2) at the first gasket end 122 and a second tapered end portion 134 at the second gasket end 124. The first tapered end portion 232 and the second tapered end portion 134 can help guide fluid in the pipeline through the main passage 130 and reduce the likelihood of fluid creeping in between the gasket 120 and the inner wall, which can displace the repair stent 105, and in some cases can drag the repair stent 105 downstream. In some example aspects, a plurality of the repair stents 105 can be joined together in series in the axial direction, relative to the stent axis 110, to form a lengthened repair stent 105 for repairing larger cracks or damage in the pipeline.

Example aspects of the gasket 120 can comprise a flexible, resilient, and/or compressible material. In the present aspect, the gasket 120 can comprise a synthetic rubber material, such as, for example, EPDM (ethylene propylene diene monomer) rubber. In other aspects, the gasket 120 can be formed from another rubber material such as neoprene, natural rubber, foam, epoxy, silicone, a resin-soaked cloth, or any other suitably flexible rubber or non-rubber material or combination of materials. In some aspects, the outer gasket surface 126 can be substantially smooth; however, in the present aspect, the outer gasket surface 126 or portions thereof can be textured. The textured outer gasket surface 126 can improve the grip of the outer gasket surface 126 on the inner wall of the pipeline, as described in further detail below.

For example, the outer gasket surface 126 can define a plurality of raised ridges 136 extending radially outward relative to the stent axis 110 and a plurality of recessed dimples 140 formed between and disposed radially inward of the raised ridges 136, relative to the stent axis 110. In the present aspect, the raised ridges 136 can be arranged in a crisscross or waffle pattern. For example, the raised ridges 136 can comprise a plurality of generally vertical ridges 136a and a plurality of generally horizontal ridges 136b arranged perpendicular to and intersecting the vertical ridges 136a. In other aspects, the raised ridges 136 can be arranged to define any other suitable pattern. In some aspects, each of the raised ridges 136 can define a substantially square or rectangular cross-section having substantially angular edges. However, in other aspects, such as the present aspect, each of the raised ridges 136 can be curved at a radially outer end 138 thereof, relative to the stent axis 110. In some aspects, the curved radially outer ends 138 of the raised ridges 136 can provide an improved grip with the inner wall of the pipeline, as compared to ridges 136 defining a substantially square or rectangular profile, as the curved radially outer ends 138 may more easily conform to variations on the inner wall of the pipeline.

The recessed dimples 140 can be defined between the vertical ridges 136a and the horizontal ridges 136b. Each of the recessed dimples 140 can be substantially square shaped in the present aspect, though in other aspects, the recessed dimples 140 can define any other suitable shape, including but not limited to rectangular, circular, triangular, or the like. The recessed dimples 140 can be arranged in a plurality of rows and a plurality of columns. The columns of the recessed dimples 140 and the vertical ridges 136a can extend circumferentially about the gasket 120, relative to the stent axis 110. The rows of the recessed dimples 140 and the horizontal ridges 136b can extend axially along the gasket 120, relative to the stent axis 110. According to example aspects, biasing the raised ridges 136 against the inner wall of the pipeline in the expanded configuration can create a suction force within the recessed dimples 140, which can aid in retaining the repair stent 105 against the inner wall. In other aspects, the outer gasket surface 126 may not comprise the raised ridges 136 as described, but can be otherwise textured, uneven, bumpy, rough, or non-smooth. For example, in other aspects, the outer gasket surface 126 of the gasket 120 can comprise an abrasive material, or can comprise projections, spikes, or grippers, or the like extending therefrom for improving the grip of the gasket 120 on the inner wall of the pipeline.

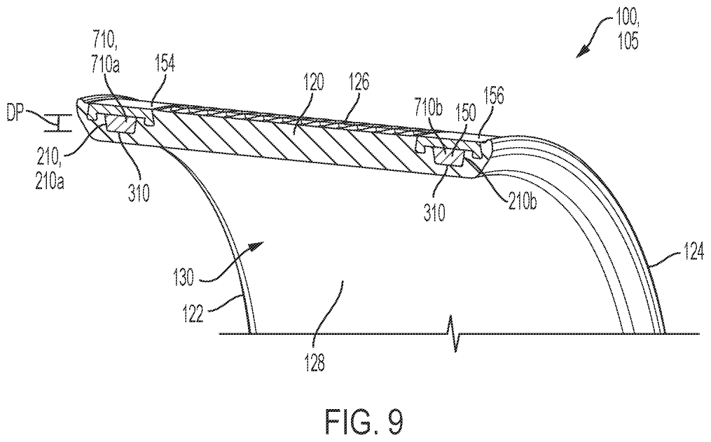

Example aspects of the gasket 120 can define one or more axial gasket channels 142 extending axially therethrough from the first gasket end 122 to the second gasket end 124, relative to the stent axis 110. Each of the gasket channels 142 can be oriented parallel with the main passage 130 of the gasket 120 and disposed radially between the inner gasket surface 128 and the outer gasket surface 126, relative to the stent axis 110. Each of the gasket channels 142 can define a channel opening 144 formed at both the first gasket end 122 and the second gasket end 124, and the channel openings 144 can provide access to the corresponding gasket channels 142. The gasket channels 142 can be spaced circumferentially about the gasket 120, relative to the stent axis 110, as shown. Example aspects of the structural chassis 150 can comprise one or more axial reinforcement rods 152, and each of the axial reinforcement rods 152 can be received in a corresponding one of the gasket channels 142. The reinforcement rods 152 can be provided to increase the stiffness of the repair stent 105 along its length L. Other aspects of the structural chassis 150 may not comprise the reinforcement rods 152, such as the aspect shown in FIG. 9.

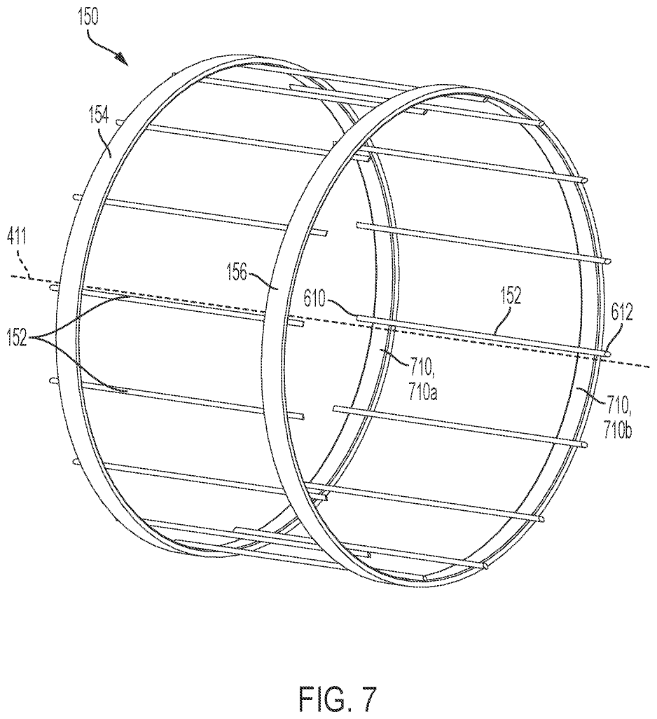

The outer gasket surface 126 of the gasket 120 can further define one or more circumferential grooves 210 (shown in FIG. 2). For example, the circumferential grooves 210 can comprise a first circumferential groove 210a (shown in FIG. 2) formed proximate to the first gasket end 122 and a second circumferential groove 210b (shown in FIG. 2) formed proximate to the second gasket end 124. The structural chassis 150 can further comprise one or more annular reinforcement rings 710 (shown in FIG. 7). For example, the reinforcement rings 710 can comprise a first reinforcement ring 710a (shown in FIG. 7) disposed within the first circumferential groove 210a and a second reinforcement ring 710b (shown in FIG. 7) disposed within the second circumferential groove 210b. Other aspects of the repair stent 105 can comprise more or fewer of the circumferential grooves 210 and the annular reinforcement rings 710. Each of the annular reinforcement rings 710 can comprise a reinforcement material, such as, for example and without limitation, epoxy, spring rubber, hard rubber, or the like.

In some aspects, such as aspects wherein the first and annular reinforcement rings 710a,b comprise a spring rubber or hard rubber reinforcement material, the annular reinforcement rings 710a,b can be slipped over the first and/or second gasket ends 122,124 and into the corresponding first or second circumferential grooves 210a,b, respectively. In aspects wherein the annular reinforcement rings 710 comprise an epoxy reinforcement material, the first and second reinforcement rings 710a,b can be formed by applying an uncured epoxy material within the first and second circumferential grooves 210a,b. The epoxy reinforcement material can be substantially flexible when initially applied within the first and second circumferential grooves 210a,b, which can allow the repair stent 105 to fold, bend, compress, and/or collapse to the collapsed configuration. The epoxy reinforcement material can be cured once the repair stent 105 is positioned at the desired location in the pipeline in the expanded configuration. As the epoxy reinforcement material cures, the first and second reinforcement rings 710a,b can become more rigid and can provide even, circumferential support to the repair stent 105 at the first gasket end 122 and the second gasket end 124. The epoxy reinforcement material can be configured to cure on its own over time or can be cured with UV (ultraviolet) radiation or any other suitable type of radiation or curing technique.

Further, in some aspects, the structural chassis 150 can comprise an annular first groove cover 154 and an annular second groove cover 156. The first groove cover 154 can extend circumferentially about the gasket 120, relative to the stent axis 110, and can cover and protect the first circumferential groove 210a and the first reinforcement ring 710a at the first gasket end 122. The second groove cover 156 can extend circumferentially about the gasket 120, relative to the stent axis 110, and can cover and protect the second circumferential groove 210b and the second reinforcement ring 710b at the second gasket end 124. In other aspects, the first and second reinforcement rings 710a,b and/or the first and second groove covers 154,156 can extend only partially about the circumference of the gasket 120.

The first and second groove covers 154,156 can comprise a resilient, flexible metal material, such as rubber, for example and without limitation. In some aspects, the rubber material of the first and second groove covers 154,156 can be EPDM rubber. In other aspects, the rubber material can be, for example and without limitation, NBR (nitrile butadiene rubber) or polyurethane. In other aspects, the first and second groove covers 154,156 can comprise any other suitable resilient, flexible rubber or non-rubber material or combination of materials. Optionally, the material of the first and second groove covers 154, 156 can be an NSF certified material that can comply with various public health safety standards. For example, in some aspects, the material can be approved as safe for use in drinking-water applications. Other aspects of the repair stent 105 may not comprise the first and second groove covers 154,156, and the first and second reinforcement rings 710a,b can be exposed. Each of the gasket channels 142 and the reinforcement rods 152 can be disposed radially inward of and can extend axially between the first reinforcement ring 710a and the second reinforcement ring 710b, relative to the stent axis 110. Thus, the first and second reinforcement rings 710a,b can provide rigid, circumferential support to the gasket 120 at the first gasket end 122 and the second gasket end 124, and the reinforcement rods 152 can provide rigid, axial support, relative to the stent axis 110, to the gasket 120 along its length L.

The repair stent 105 can be configurable in the expanded configuration and the collapsed configuration. In the collapsed configuration, the flexible gasket 120 can be folded, bent, compressed, collapsed, and/or otherwise reconfigured to reduce the width W and/or diameter D of the repair stent 105 as compared to the expanded configuration. The flexibility of the gasket 120, the first and second groove covers 154,156, and the reinforcement rings 710 can facilitate arranging the repair stent 105 in the collapsed configuration. The reduced width W and/or diameter D of the repair stent 105 in the collapsed configuration can allow the repair stent 105 to be easily inserted into and transported through the pipeline to the location of damage.

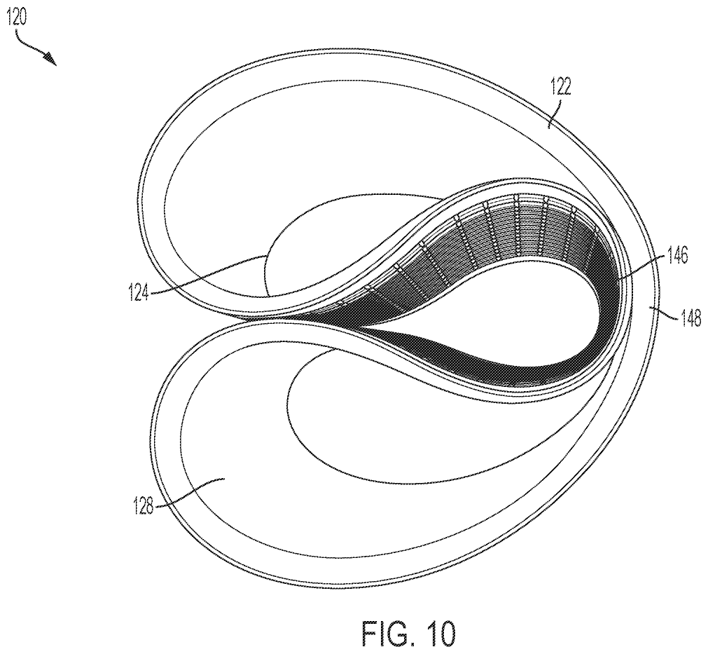

A force (e.g., a pushing or pulling force) can be applied to the repair stent 105 to fold or otherwise configure the repair stent 105 in the collapsed configuration. In one example aspect, portions of the gasket 120 can be collapsed radially inward, relative to the stent axis 110, between adjacent reinforcement rods 152. In another example aspect, a first gasket side 146 of the gasket 120 can be pushed radially inward, relative to the stent axis 110, towards an opposite second gasket side 148 of the gasket 120 to fold the gasket 120 into a C-shape, as shown in FIG. 10. In other example aspects, the repair stent 105 can be collapsed in any suitable manner to reduce the width W and/or diameter D thereof. When the force is removed, the resiliency of the gasket 120 and the first and second groove covers 154,156 can bias the repair stent 105 back to the expanded configuration, and the first and second reinforcement rings 710a,b can reinforce the first and second gasket ends 122, 124, respectively, to hold the outer gasket surface 126 against the inner wall of the pipeline. In aspects wherein the first and second reinforcement rings 710a,b comprise an epoxy material, the first and second reinforcement rings 710a,b can cure and stiffen once in the expanded configuration. The reinforcement rods 152 can further provide rigid support to the gasket 120 at and between the first and second gasket ends 122,124.

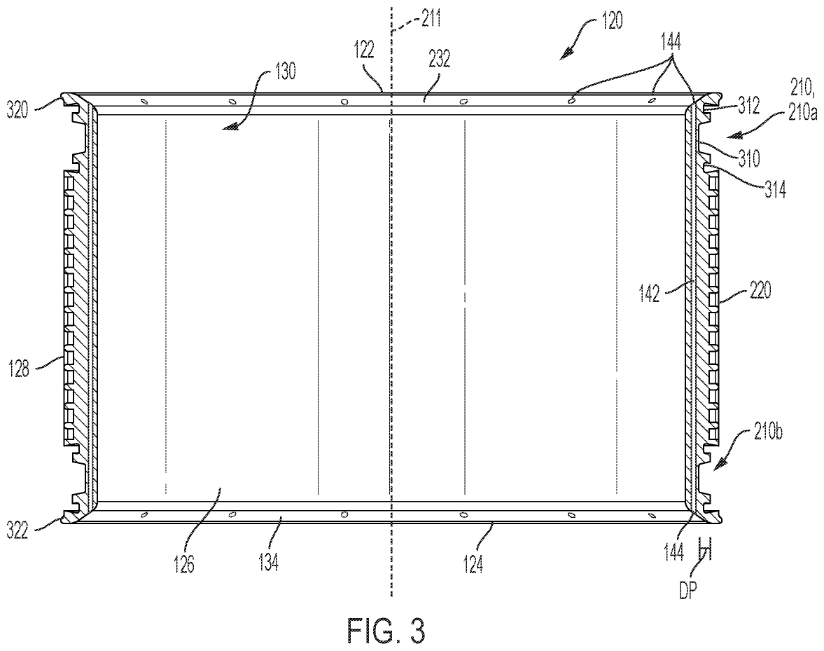

FIG. 2 is a perspective view of the gasket 120, and FIG. 3 is a cross-sectional view of the gasket 120 taken along line 3-3 in FIG. 2. Referring to FIG. 2, the gasket 120 can define the first gasket end 122, the second gasket end 124, the inner gasket surface 128, and the outer gasket surface 126. The first tapered end portion 232 can be defined at the first gasket end 122, and the second tapered end portion 134 can be defined at the second gasket end 124. The main passage 130 of the gasket 120 can be defined by the inner gasket surface 128 and can extend centrally through the gasket 120. The plurality of gasket channels 142 can extend axially through the gasket 120 from the first gasket end 122 to the second gasket end 124, radially between the outer gasket surface 126 and the inner gasket surface 128, relative to a gasket axis 211 of the gasket 120. The gasket axis 211 can be configured to substantially align with the stent axis 110. The outer gasket surface 126 can define the first circumferential groove 210a formed adjacent to the first gasket end 122 and the second circumferential groove 210b formed adjacent to the second gasket end 124. The outer gasket surface 126 can further define the raised ridges 136 and the recessed dimples 140, which can define a textured portion 220 of the outer gasket surface 126. The textured portion 220 can be disposed axially between the first circumferential groove 210a and the second circumferential groove 210b, relative to the gasket axis 211.

Referring to FIG. 3, the gasket 120 can define a first sealing lip 320 extending radially outward at the first gasket end 122 and a second sealing lip 322 extending radially outward at the second gasket end 124, relative to the gasket axis 211. The first circumferential groove 210a can be defined axially between the first sealing lip 320 and the textured portion 220 of the gasket 120, relative to the gasket axis 211. The second circumferential groove 210b can be defined axially between the second sealing lip 322 and the textured portion 220 of the gasket 120, relative to the gasket axis 211. Each of the first circumferential groove 210a and the second circumferential groove 210b can define a central reinforcement notch 310 extending circumferentially about the gasket 120, relative to the gasket axis 211. The central reinforcement notch 310 of the first circumferential groove 210a can be configured to receive the first reinforcement ring 710a (shown in FIG. 7), and the central reinforcement notch 310 of the second circumferential groove 210b can be configured to receive the second reinforcement ring 710b (shown in FIG. 7). Each of the central reinforcement notches 310 can extend radially into the gasket 120, relative to the gasket axis 211, at a depth DP. In aspects of the repair stent 105 (shown in FIG. 1) comprising the gasket channels 142 and the reinforcement rods 152 (shown in FIG. 1), the depth DP to which the central reinforcement notches 310 can extend may be reduced as compared to aspects not comprising the gasket channels 142 and the reinforcement rods 152. An aspect of the repair stent 105 not comprising the gasket channels 142 and reinforcement rods 152 is illustrated in FIG. 9.

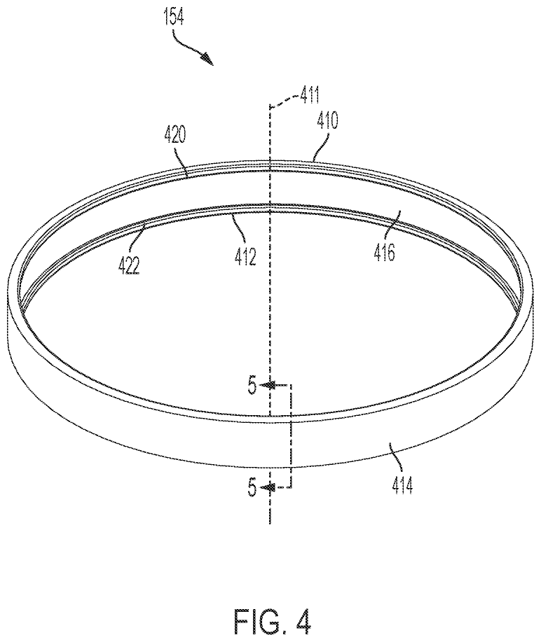

Each of the first circumferential groove 210a and second circumferential groove 210b further defines an outer snap notch 312 and inner snap notch 314 extending circumferentially about the gasket 120, relative to the gasket axis 211. The outer snap notch 312 and the inner snap notch 314 can be formed as dovetail notches 312,314 in the present aspect, the cross-sectional shape of which can generally define an isosceles trapezoid. Each central reinforcement notch 310 can be disposed axially between the corresponding outer snap notch 312 and inner snap notch 314, relative to the gasket axis 211. The outer snap notch 312 can be configured to receive an outer snap tab 420 (shown in FIG. 4) of the corresponding first or second groove cover 154,156 (shown in FIG. 1), and the inner snap notch 314 can be configured to receive an inner snap tab 422 (shown in FIG. 4) of the corresponding first or second groove cover 154,156. Snapping the outer snap tab 420 into the outer snap notch 312 and the inner snap tab 422 into the inner snap notch 314 can retain the corresponding first or second groove cover 154,156 on the gasket 120. In some aspects, the first and second groove covers 154,156 can be further coupled to the gasket 120 by an adhesive or other suitable fastener to ensure that the first and second groove covers 154,156 are sufficiently secured to the gasket 120.

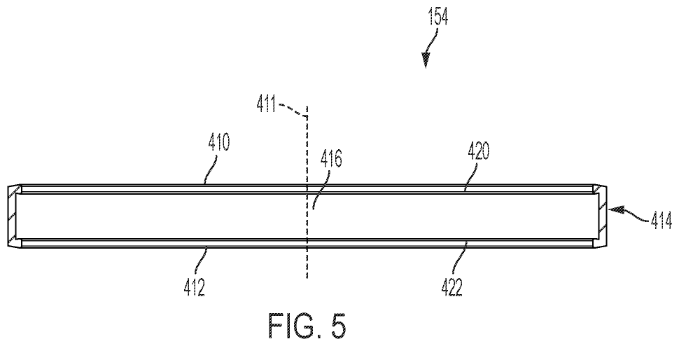

FIG. 4 illustrates a perspective view of the first groove cover 154, and FIG. 5 illustrates a cross-sectional view of the first groove cover 154 taken along line 5-5 in FIG. 4. The first groove cover 154 can be substantially the same as the second groove cover 156 (shown in FIG. 1). The first groove cover 154 can be substantially ring-shaped in the present aspect. Referring to FIG. 4, the first groove cover 154 can define a first cover end 410, a second cover end 412 opposite the first cover end 410, an outer cover surface 414, and an inner cover surface 416 opposite the outer cover surface 414. The outer cover surface 414 can be substantially smooth in the present aspect but may be textured or non-smooth in other aspects. The inner cover surface 416 can define the outer snap tab 420 extending radially inward at the first cover end 410 and the inner snap tab 422 extending radially inward at the second cover end 412, relative to a chassis axis 411 extending centrally through the first and second groove covers 154,156. The chassis axis 411 can be configured to substantially align with the gasket axis 211 (shown in FIG. 2) and the stent axis 110 (shown in FIG. 1). Each of the outer snap tab 420 and the inner snap tab 422 can extend circumferentially about the inner cover surface 416, relative to the chassis axis 411. As shown in FIG. 5, the outer and inner snap tabs 420,422 can be formed as dovetail tabs 420,422 in the present aspect, the cross-sectional shape of which can generally define an isosceles trapezoid. The outer and inner snap tabs 420,422 of the first groove cover 154 can be configured to snap into the outer and inner snap notches 312,314 (shown in FIG. 3), respectively, of the corresponding the first circumferential groove 210a (shown in FIG. 2) to cover and protect the first reinforcement ring 710a (shown in FIG. 7). The second groove cover 156 can snap into the second circumferential groove 210b in the same manner.

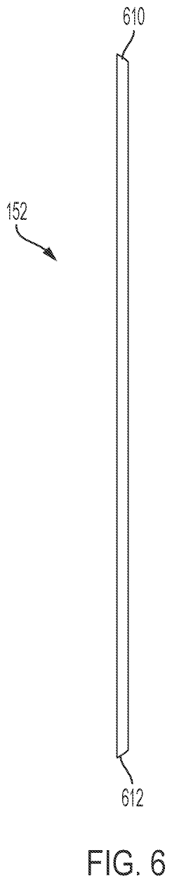

FIG. 6 illustrates one of the reinforcement rods 152 in accordance with an example aspect of the present disclosure. In example aspects, each of the reinforcement rods 152 can be elongate and cylindrical and can define a circular cross-sectional shape. In other aspects, the reinforcement rods 152 can define any other suitable cross-sectional shape, including, but not limited to, rectangular. Each of the reinforcement rods 152 can define a first rod end 610 and a second rod end 612 opposite the first rod end 610. In some aspects, the first rod end 610 and the second rod end 612 can be angled to substantially match the angle of the first and second tapered end portions 232, 134 (shown in FIG. 1) of the gasket 120 (shown in FIG. 1). As such, when the reinforcement rod 152 is assembled with the gasket 120, the first rod end 610 of the reinforcement rod 152 can be substantially flush with the first tapered end portion 232, and the second rod end 612 of the reinforcement rod 152 can be substantially flush with the second tapered end portion 134. In other aspects, and first rod end 610 and/or the second rod end 612 may not be angled.

FIG. 7 illustrates an example aspect of the structural chassis 150 of the repair stent 105 (shown in FIG. 1). The structural chassis 150 can comprise the first and second reinforcement rings 710a,b, the first and second groove covers 154,156, and the reinforcement rods 152. The first and second reinforcement rings 710a,b can be disposed radially inward of and concentric to the first and second groove covers 154,156, respectively, relative to the chassis axis 411. The first and second reinforcement rings 710a,b can further be axially aligned with the first and second groove covers 154,156, relative to the chassis axis 411, such that the first and second groove covers 154,156 can cover and protect the first and second reinforcement rings 710a,b. Furthermore, the reinforcement rods 152 can be arranged circumferentially about an inner diameter of the structural chassis 150, relative to the chassis axis 411. The reinforcement rods 152 can be disposed radially inward of the first and second reinforcement rings 710a,b and can extend axially therebetween, relative to the chassis axis 411. In the present aspect, the first rod end 610 of each reinforcement rod 152 can extend axially outward beyond the first reinforcement ring 710a, and the second rod end 612 of each reinforcement rod 152 can extend axially outward beyond the second reinforcement ring 710b, relative to the chassis axis 411.

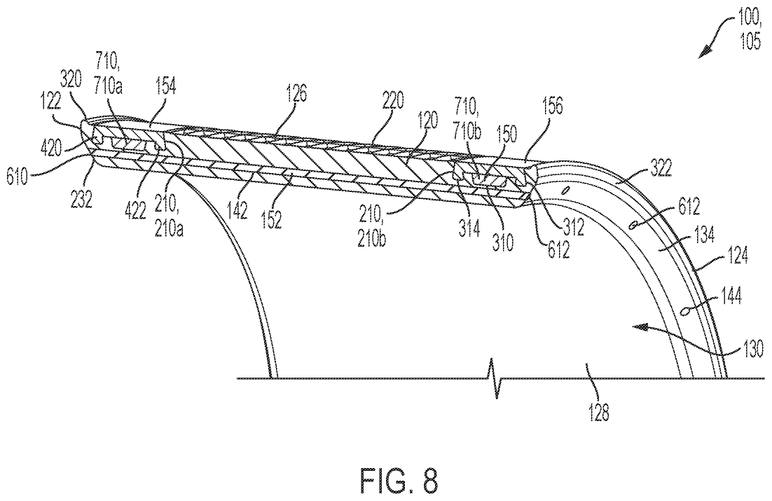

FIG. 8 illustrates a cross-sectional view of the repair stent 105 taken along line 8-8 in FIG. 1. The repair stent 105 comprises the gasket 120 and the structural chassis 150 for reinforcing the gasket 120. The gasket 120 can define the first gasket end 122 and the second gasket end 124. The gasket 120 can further define the outer gasket surface 126 and the inner gasket surface 128. The inner gasket surface 128 can define the main passage 130 through which fluid in the pipeline can flow in the expanded configuration of the repair stent 105. The first tapered end portion 232 can be defined at the first gasket end 122, and the second tapered end portion 134 can be defined at the second gasket end 124. Example aspects of the gasket 120 can comprise a flexible, resilient, and compressible material that can seal against the inner wall of the pipeline in the expanded configuration and that can allow the repair stent 105 to fold, collapse, bend and/or compress in the collapsed configuration.

In example aspects, the outer gasket surface 126 can define the first circumferential groove 210a proximate to the first gasket end 122 and the second circumferential groove 210b proximate to the second gasket end 124. The textured portion 220 of the outer gasket surface 126 can be disposed axially between the first and second circumferential grooves 210a,b, relative to the stent axis 110 (shown in FIG. 1). The structural chassis 150 can comprise the first reinforcement ring 710a disposed within the central reinforcement notch 310 of the first circumferential groove 210a and the second reinforcement ring 710b disposed within the central reinforcement notch 310 of the second circumferential groove 210b. An uncured reinforcement material can be applied within the central reinforcement notches 310 to form the first and second reinforcement rings 710a,b. The reinforcement material can be flexible while uncured, and the repair stent 105 can be folded or otherwise arranged in the collapsed configuration while the uncured reinforcement material is flexible. The repair stent 105 can be transported through the pipeline in the collapsed configuration to the location of the damage and can then be biased to the expanded configuration. For example, in the present aspect, the resiliency of the gasket 120, the first and second reinforcement rings 710a,b, and the first and second groove covers 154,156 can bias the repair stent 105 to the expanded configuration. In aspects of the reinforcement rings 710 comprising an epoxy reinforcement material, the epoxy reinforcement material can cure over time or under the application of radiation, and the first and second reinforcement rings 710a,b can become more rigid to provide structural support to the gasket 120 at the first gasket end 122 and the second gasket end 124.

The first groove cover 154 can lock into the first circumferential groove 210a and can cover and protect the first reinforcement ring 710a. The second groove cover 156 can lock into the second circumferential groove 210b and can cover and protect the second reinforcement ring 710b. Each of the first and second circumferential grooves 210a,b can define the corresponding outer snap notch 312 and the inner snap notch 314. Each of the first and second groove covers 154,156 can comprise the corresponding outer snap tab 420 and the inner snap tab 422. The outer snap tab 420 of the first groove cover 154 can snap into the outer snap notch 312 of the first circumferential groove 210a, and the inner snap tab 422 of the first groove cover 154 can snap into the inner snap notch 314 of the first circumferential groove 210a. In the same manner, the outer snap tab 420 of the second groove cover 156 can snap into the outer snap notch 312 of the second circumferential groove 210b, and the inner snap tab 422 of the second groove cover 156 can snap into the inner snap notch 314 of the second circumferential groove 210b. In example aspects, the resiliency of the gasket 120 can allow the dovetail snap notches 312,314 to flex and widen as the dovetail snap tabs 420,422 are pushed into the outer and inner snap notches 312,314. The dovetail snap notches 312,314 can then rebound to their original shape once the snap tabs 420,422 have been fully inserted to retain the snaps tabs 420,422 therein. The first and second groove covers 154,156 can thereby be retained in the first and second circumferential grooves 210a,b. In some aspects, the first and second groove covers 154,156 can be further secured to the gasket 120 by an adhesive or other fastener or fastening technique. As described above, the first and second groove covers 154,156 can comprise a flexible, resilient material that can bias the repair stent 105 to the expanded configuration, but which can fold or bend under a force in the collapsed configuration.

In some aspects, the first sealing lip 320 formed at the first gasket end 122 and the second sealing lip 322 formed at the second gasket end 124 can extend radially outward beyond the first groove cover 154 and the second groove cover 156, respectively, relative to the stent axis 110. In the expanded configuration, the first and second sealing lips 320,322 can be biased into engagement with and can seal with the inner wall of the pipeline to improve the seal between the repair stent 105 and the inner wall at the first gasket end 122 and the second gasket end 124. The first and second reinforcement rings 710a,b can provide added structural support to the gasket 120 at the first and second gasket ends 122, 124 to support the sealing of the first and second sealing lips 320,322 with the inner wall.

Example aspects of the gasket 120 can further define the gasket channels 142 spaced about the circumference thereof. The gasket channels 142 can extend axially through the gasket 120 from the first gasket end 122 to the second gasket end 124 and can be disposed radially between the inner gasket surface 128 and the outer gasket surface 126, relative to the stent axis 110. Each of the reinforcement rods 152 can be inserted into one of the gasket channels 142 through a corresponding one of the channel openings 144. The angled first rod end 610 of each reinforcement rod 152 can be configured to lie substantially flush with the first tapered end portion 232 of the gasket 120, and the angled second rod end 612 of each reinforcement rod 152 can be configured to lie substantially flush with the second tapered end portion 134 of the gasket 120. The reinforcement rods 152 can be configured to increase the stiffness of the repair stent 105 at the first and second gasket ends 122, 124 and along the length L of the gasket 120.

An example method of repairing a damaged pipeline can comprise configuring the repair stent 105 in the collapsed configuration, transporting the repair stent 105 through the pipeline to a crack or other damage, expanding the repair stent 105 to the expanded configuration to seal the gasket 120 with the inner wall of the pipeline, and reinforcing the gasket 120 at the first and second gasket ends 122, 124 thereof with the first and second reinforcement rings 710a,b. In some aspects, the method can further comprise applying an uncured reinforcement material within the first and second circumferential grooves 210a,b of the gasket 120 prior to configuring the repair stent 105 in the collapsed configuration and curing the reinforcement material to form the rigid first and second reinforcement rings 710a,b after expanding the repair stent 105 to the expanded configuration. In some aspects, curing the reinforcement material can comprise allowing the reinforcement material to cure on its own over time, while in other aspects, curing the reinforcement material can comprise applying radiation, such as UV radiation, to the reinforcement material. In some aspects, expanding the repair stent 105 to the expanded configuration can comprise biasing the repair stent 105 to the expanded configuration by the resiliency of the gasket 120 and/or the first and second groove covers 154,156.

FIG. 9 illustrates a cross-sectional view of the repair stent 105 in accordance with another aspect of the present disclosure. In the present aspect, the gasket 120 does not comprise the gasket channels 142 (shown in FIG. 1), and the structural chassis 150 does not comprise the reinforcement rods 152 (shown in FIG. 1). While the previous gasket 120 typically needed a certain thickness to allow for forming the gasket channels 142 therethrough, the gasket 120 of the present aspect need not meet the same thickness requirement. Thus, the central reinforcement notches 310 of the first and second circumferential grooves 210a,b can extend radially inward to a greater depth DP, relative to the stent axis 110 (shown in FIG. 1), as compared to the gasket 120 comprising the gasket channels 142. More of the reinforcement material can be applied within the deeper central reinforcement notches 310 to form thicker and stronger first and second reinforcement rings 710a,b.

FIG. 10 illustrates the gasket 120 of the pipe repair device 100 (shown in FIG. 1) in the collapsed configuration, according to an example aspect of the present disclosure. In the present aspect, the first gasket side 146 of the gasket 120 can be pushed radially inward, relative to the gasket axis 211 (shown in FIG. 2), towards the opposite second gasket side 148 of the gasket 120. The gasket 120 can thereby be folded to substantially define a C-shape or U-shape in the collapsed configuration, as shown. When the gasket 120 is assembled with the structural chassis 150 (shown in FIG. 1), the pipe repair device 100 can be similarly folded to the collapsed configuration.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A structural chassis for a pipe repair stent, the structural chassis comprising:
a first reinforcement ring configured to be received in a first circumferential groove of a gasket;
a second reinforcement ring, wherein a chassis axis extends centrally through the first reinforcement ring and the second reinforcement ring, the second reinforcement ring axially spaced from the first reinforcement ring, relative to the chassis axis, and configured to be received in a second circumferential groove of the gasket;
a first groove cover axially aligned with and disposed radially outward of the first reinforcement ring, relative to the chassis axis, to cover and protect the first reinforcement ring; and
a second groove cover axially aligned with and disposed radially outward of the second reinforcement ring, relative to the chassis axis, to cover and protect the second reinforcement ring.

2. The structural chassis of claim 1, wherein;
each of the first groove cover and the second groove cover defines an inner cover surface, an outer cover surface, a first cover end, and a second cover end;
the inner cover surface of the first groove cover confronts the first reinforcement ring; and
the inner cover surface of the second groove cover confronts the second reinforcement ring.

3. The structural chassis of claim 2, wherein:
the inner cover surface of each of the first and second groove cover defines a first snap tab extending radially inward at the first cover end, relative to the chassis axis, and a second snap tab extending radially inward at the second cover end, relative to the chassis axis;
the first snap tab of the first groove cover is configured to engage a first snap notch of the first circumferential groove, and the second snap tab of the first groove cover is configured to engage a second snap notch of the first circumferential groove; and
the first snap tab of the second groove cover is configured to engage a first snap notch of the second circumferential groove, and the second snap tab of the second groove cover is configured to engage a second snap notch of the second circumferential groove.

4. The structural chassis of claim 3, wherein:
the first reinforcement ring is disposed axially between the first snap tab of the first groove cover and the second snap tab of the first groove cover, relative to the chassis axis; and
the second reinforcement ring is disposed axially between the first snap tab of the second groove cover and the second snap tab of the second groove cover, relative to the chassis axis.

5. The structural chassis of claim 3, wherein:
the first snap tab and the second snap tab of the first groove cover extend circumferentially about the inner cover surface of the first groove cover, relative to the chassis axis; and
the first snap tab and the second snap tab of the second groove cover extend circumferentially about the inner cover surface of the second groove cover, relative to the chassis axis.

6. The structural chassis of claim 5, wherein the first snap tab is a dovetail tab, the cross-sectional shape of the dovetail tab defining an isosceles trapezoid.

7. The structural chassis of claim 1, further comprising a reinforcement rod disposed radially inward of the first reinforcement ring and the second reinforcement ring, relative to the chassis axis, wherein the reinforcement rod extends axially between the first reinforcement ring and the second reinforcement ring, relative to the chassis axis.

8. The structural chassis of claim 7, wherein the reinforcement rod is one of a plurality of reinforcement rods, the plurality of reinforcement rods arranged circumferentially about an inner diameter the structural chassis, relative to the chassis axis.

9. The structural chassis of claim 7, wherein the reinforcement rod defines a first rod end extending axially outward beyond the first reinforcement ring, relative to the chassis axis, and a second rod end extending axially outward beyond the second reinforcement ring, relative to the chassis axis.

10. The structural chassis of claim 9, wherein the first rod end is an angled first rod end and the second rod end is an angled second rod end.

11. The structural chassis of claim 1, wherein:
each of the first reinforcement ring and the second reinforcement ring are substantially annular; and
each of the first groove cover and the second groove cover are substantially annular.

12. The structural chassis of claim 1, wherein each of the first reinforcement ring and the second reinforcement ring comprise an epoxy material.

13. A pipe repair stent comprising:
a gasket defining a first gasket end, a second gasket end, an outer gasket surface, and an inner gasket surface, the inner gasket surface defining a main passage centrally through the gasket, a stent axis extending centrally through the main passage, the outer gasket surface defining a first circumferential groove that is oriented proximate to the first gasket end and a second circumferential groove that is axially spaced from the first circumferential groove, relative to the stent axis, and oriented proximate to the second gasket end; and
a structural chassis comprising a first reinforcement ring disposed in the first circumferential groove and a second reinforcement ring disposed in the second circumferential groove, the structural chassis further comprising a first groove cover disposed radially outward of and covering the first reinforcement ring, relative to the stent axis, and a second groove cover disposed radially outward of and covering the second reinforcement ring, relative to the stent axis.

14. The pipe repair stent of claim 13, wherein;
each of the first and second circumferential grooves defines an reinforcement notch and a first snap notch;
the first reinforcement ring is received in the reinforcement notch of the first circumferential groove, and the second reinforcement ring is received in the reinforcement notch of the second circumferential groove;
each of the first groove cover and the second groove cover defines a first snap tab extending radially inward, relative to the stent axis; and
the first snap tab of the first groove cover is snapped into the first snap notch of the first circumferential groove, and the first snap tab of the second groove cover is snapped into the first snap notch of the second circumferential groove.

15. The pipe repair stent of claim 14, wherein:
each of the first and second circumferential grooves further defines a second snap notch;
the reinforcement notch of the first circumferential groove is disposed axially between the first snap notch and the second snap notch of the first circumferential groove, relative to the stent axis;
the reinforcement notch of the second circumferential groove is disposed axially between the first snap notch and the second snap notch of the second circumferential groove, relative to the stent axis;
each of the first and second groove cover further defines a second snap tab extending radially inward, relative to the stent axis; and
the second snap tab of the first groove cover snaps into the second snap notch of the first circumferential groove, and the second snap tab of the second groove cover snaps into the second snap notch of the second circumferential groove.

16. The pipe repair stent of claim 15, wherein:
the first snap tab and the second snap tab of the first groove cover extend circumferentially about an inner cover surface of the first groove cover, relative to the stent axis; and
the first snap tab and the second snap tab of the second groove cover extend circumferentially about an inner cover surface of the second groove cover, relative to the stent axis.

17. The pipe repair stent of claim 13, wherein the gasket defines a first sealing lip extending radially outward at the first gasket end, relative to the stent axis, and a second sealing lip extending radially outward at the second gasket end, relative to the stent axis.

18. The pipe repair stent of claim 17, wherein the outer gasket surface defines a textured portion comprising a plurality of raised ridges and recessed dimples, the first circumferential groove disposed axially between the first sealing lip and the textured portion, relative to the stent axis, and the second circumferential groove disposed axially between the second sealing lip and the textured portion, relative to the stent axis.

19. The pipe repair stent of claim 13, wherein:
the gasket defines a gasket channel extending axially therethrough from the first gasket end to the second gasket end, relative to the stent axis;
the gasket channel is disposed radially between the outer gasket surface and the inner gasket surface, relative to the stent axis; and
the structural chassis further comprises a reinforcement rod received in the gasket channel.

20. The pipe repair stent of claim 19, wherein:
the gasket channel is one of a plurality of gasket channels arranged circumferentially about the gasket, relative to the stent axis; and
the reinforcement rod is one of a plurality of reinforcement rods, each of the plurality of reinforcement rods received in one of the plurality of gasket channels.

21. The pipe repair stent of claim 19, wherein the reinforcement rod defines a first rod end extending axially outward beyond the first reinforcement ring, relative to the stent axis, and a second rod end extending axially outward beyond the second reinforcement ring, relative to the stent axis.

22. The pipe repair stent of claim 21, wherein:
the gasket tapers generally from the outer gasket surface to the inner gasket surface at the first gasket end to define a first tapered end portion;
the gasket tapers generally from the outer gasket surface to the inner gasket surface at the second gasket end to define a second tapered end portion;
the first rod end of the reinforcement rod is an angled first rod end, the angled first rod end substantially flush with the first tapered end portion; and
the second rod end of the reinforcement rod is an angled second rod end, the angled second rod end substantially flush with the second tapered end portion.

23. A method of repairing a damaged pipeline with a pipe repair stent comprising:
providing a gasket of the pipe repair stent, the gasket defining a first gasket end, a second gasket end, an outer gasket surface, and an inner gasket surface, the outer gasket surface defining a first circumferential groove that is oriented proximate to the first gasket end and a second circumferential groove that is oriented proximate to the second gasket end, the pipe repair stent defining a stent axis;
transporting the pipe repair stent through a pipeline in a collapsed configuration to a location of damage;
expanding the pipe repair stent to an expanded configuration to seal the gasket with an inner wall of the pipeline; and
reinforcing the gasket with a first reinforcement ring disposed in the first circumferential groove and a second reinforcement ring disposed in the second circumferential groove.

24. The method of claim 23, wherein the method further comprises:
applying an uncured reinforcement material within the first circumferential groove and the second circumferential groove prior to transporting the pipe repair stent through a pipeline in the collapsed configuration; and
curing the uncured reinforcement material to form the first reinforcement ring within the first circumferential groove and the second reinforcement ring within the second circumferential groove after expanding the pipe repair stent to the expanded configuration.

25. The method of claim 24, wherein curing the uncured reinforcement material comprises allowing the uncured reinforcement material to cure on its own over time.

26. The method of claim 24, wherein curing the uncured reinforcement material comprises applying radiation to the uncured reinforcement material.

27. The method of claim 24, wherein:
the uncured reinforcement material is an uncured epoxy material;
the first reinforcement ring is a rigid first epoxy ring; and
the second reinforcement ring is a rigid second epoxy ring.

28. The method of claim 23, further comprising covering the first reinforcement ring within the first circumferential groove with a first groove cover and covering the second reinforcement ring within the second circumferential groove with a second groove cover.

29. The method of claim 28, wherein:
covering the first reinforcement ring within the first circumferential groove with the first groove cover comprises snapping a first snap tab of the first groove cover into a first snap notch of the first circumferential groove; and
covering the second reinforcement ring within the second circumferential groove with the second groove cover comprises snapping a second snap notch of the second groove cover into a second snap notch of the second circumferential groove.

30. The method of claim 23, wherein:
the gasket defines gasket channel extending axially therethrough, relative to the stent axis, from the first gasket end to the second gasket end;
the gasket channel is disposed radially between the outer gasket surface and the inner gasket surface, relative to the stent axis; and
a reinforcement rod is received in the gasket channel.

31. The method of claim 23, wherein expanding the pipe repair stent to the expanded configuration comprises biasing the pipe repair stent to the expanded configuration by a resiliency of the gasket.
